(19) United States
(12) Patent Application Publication
(10) Pub. No.: US 2017/0314771 A1
(43) Pub. Date: Nov. 2, 2017

(54) CEILING-MOUNTED ELECTRIC FIXTURE INSTALLATION TOOLS

(71) Applicant: Konstantin L. Valtchev, Ontario (CA)

(72) Inventor: Konstantin L. Valtchev, Ontario (CA)

(21) Appl. No.: 15/582,644

(22) Filed: Apr. 29, 2017

Related U.S. Application Data
(60) Provisional application No. 62/330,302, filed on May 2, 2016.

(51) Int. Cl. F21V 21/36; B25B 27/14

(52) U.S. Cl. CPC F21V 21/36; B25B 27/14

(57) ABSTRACT

A tool that allows a person to attach a fixture to a ceiling, and do the job on their own, quickly, safely, and without frustration. The tool includes a guiding rod that is selectively attached to the ceiling mounted electric junction box, a fixture support that is movable along the length of the guiding rod, and a lock that secures the fixture support at any of a number of desired positions along the length of the guiding rod. A first embodiment of the tool is used in pairs and includes a threaded cavity at the distal end of the guiding rod that is selectively attachable to one of the pair of holding screws extending down from the junction box. The second embodiment of the tool includes a threaded section on the outside of the distal end that is selectively attachable to a junction box crossbar that has a central threaded opening. The embodiment chosen by the installer depends on the fixture design and the preference of the installer.

### CROSS REFERENCE TO RELATED APPLICATIONS

This application claims priority from U.S. Provisional Patent Application, Ser. No. 62/530,302, filed May 2, 2016, entitled Light Fixture Assembly Tools, which is incorporated herein by reference in its entirety.

### BACKGROUND OF INVENTION

### Field of the Invention

The present invention relates to the field of tools, and more particularly to a tool that allows one individual to install an electric fixture in a ceiling.

### Description of Art

As can be seen by reference to the following patents, the prior art is replete with myriad and diverse ceiling fixture mounting tools.

U.S. Pat. No. 5,387,066 to Zekowski, entitled—Electrical Fixture Installation Assist Method and Means discloses an attachment bolt formed as an elongate rod member capable of engagement with the attachment tab of a junction box, and was developed to accomplish the same purpose, but is significantly different.

U.S. Pat. No. 5,434,356 to Zekowski, entitled—Electrical Fixture Installation Assist Method discloses a device mounted to an electrical junction box, and was developed to accomplish the same purpose, but is significantly different.

U.S. Pat. No. 5,844,167 to Zekowski, entitled—Electrical Fixture Installation Assist Means has a threaded attachment rod for use in assisting the installation of an electrical fixture to a structurally mounted electrical junction box, and was developed to accomplish the same purpose, but is significantly different.

U.S. Pat. No. 6,991,352 to Garber et al, entitled—Light Fixture having a Support System discloses a device for holding the light fixture during installation, and was developed to accomplish the same purpose, but is significantly different.

U.S. Pat. No. 9,065,264 to Cooper et al, entitled—System for Mounting an Electrical Fixture to an Electrical Junction Box was developed to accomplish the same purpose, but is significantly different.

At the present time attaching a light fixture usually requires two people. One to support the fixture and the other one to connect the electric wires and align the two holes on the fixture with the two holding screws of the junction box. This will allow them to pass through the holes and to receive the threaded fixture knobs. The alignment of the holding screws with the holes is not an easy task, and to a certain extent involves guess work, because the installer cannot visualize the holding screws. It sometimes takes a considerable amount of time to align the holding screws with the holes, and push them through.

The most common method of installing an electrical fixture to a junction box is supporting the fixture which is suspended from the ceiling, and trying to connect the electrical wire leads to the wires in the electrical junction box. This can be dangerous if standing on a ladder or some other kind of support.

Other methods referenced above include the junction box having tabs carrying a threaded attachment that holds the fixture and has openings alignable with the attached holes. This method uses elongate partially threaded attachment rods having one end engageable with the attachment holes. The attachment rod has opposite threaded end portions, one end threadably engageable with the junction box and an opposite end portion.

Another method has a support system for holding the light fixture thereby allowing the user to have both hands free for wiring. This system includes a bracket configured to be mounted to an electrical box. A tether extends from the light fixture and has a connecting element for releasably attaching the tether to the bracket.

Also, an electrical quick connect member can be engaged to a support which has a connection element for forming an electrical connection with an electrical wire, and another connection element for forming an electrical connection to a fixture electrical wire.

While all of the aforementioned prior art constructions are adequate for the basic purpose and function for which they have been specifically designed, they are uniformly deficient with respect to their failure to provide a simple, efficient, and practical tool to assist one individual in attaching an electric fixture to a ceiling.

As a consequence of the foregoing situation there has existed a longstanding need for a new and improved ceiling-mounted electric fixture installation tool and the provision of such a construction is a stated objective of the present invention.

### BRIEF SUMMARY OF THE INVENTION

Briefly stated, the present invention provides a tool that allows a person to attach a fixture to a ceiling, and do the job on their own, quickly, safely, and without frustration. The tool includes a guiding rod that is selectively attached to the ceiling mounted electric junction box, a fixture support that is movable along the length of the guiding rod, and a lock that secures the fixture support at any of a number of desired positions along the length of the guiding rod. A first embodiment of the tool is used in pairs and includes a threaded cavity at the distal end of the guiding rod that is selectively attachable to one of the pair of holding screws extending down from the junction box. The second embodiment of the tool includes a threaded section on the outside of the distal end that is selectively attachable to a junction box crossbar that has a central threaded opening. The embodiment chosen by the installer depends on the fixture design and the preference of the installer.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings wherein:

FIG. 1 is a side elevational view of the guiding rod of the first embodiment of the invention, with an enlarged view of the distal end showing the threaded cavity;

FIG. 2a is a top plan view of the fixture support carried on the guiding rod;

FIG. 2b is a front elevational view thereof;

FIG. 2c is a bottom plan view thereof;

FIG. 2d is a bottom plan view thereof with the locking screw attached;

FIG. 3 is a side elevational view of the fixture support;

FIG. 4 is a side elevational view of the locking screw;

FIG. 5 is a side elevational view of the first embodiment of the tool;

FIG. 6 is a side elevational sectional view illustrating the first steps in using the first embodiment of the tool;

FIG. 7 is a view similar to FIG. 6, but showing the fixture supported on the fixture supports so that the wiring connections can be made;

FIG. 8 is a view similar to FIG. 7, but showing one of the pair of the tools being disengaged so that the fixture knob can be attached;

FIG. 9 is a view similar to FIG. 8, but showing the second of a pair of tools being disengaged;

FIG. 10 is a side elevational view of the guiding rod of the second embodiment of the invention, with an enlarged view of the distal end showing the threaded outer surface;

FIG. 11 is a plan view of the junction box crossbar with the threaded central opening;

FIG. 12 is a side elevational view of the pan head screw that is threaded to engage the central opening of the crossbar;

FIG. 13 is a side elevation sectional view of the fixture nipple holder;

FIG. 14 is a side elevational sectional view illustrating the first steps in using the second embodiment of the tool;

FIG. 15 is a view similar to FIG. 14, but showing the fixture supported so that the wiring can be done;

FIG. 16 is a view similar to FIG. 15, but showing the tool being disengaged; and

FIG. 17 is a view similar to FIG. 16, but showing the pan head screw being inserted to secure the fixture to the ceiling.

### DETAILED DESCRIPTION OF THE INVENTION

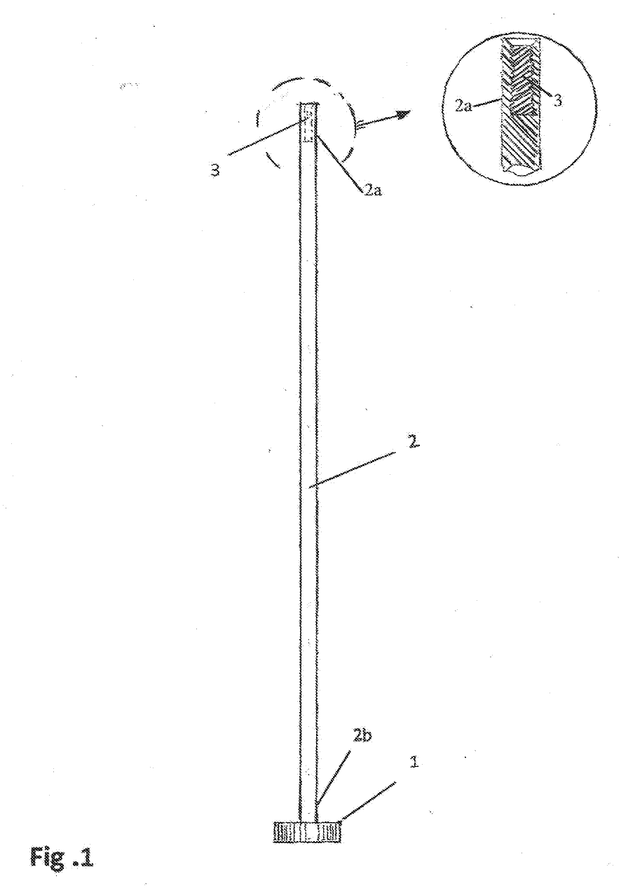

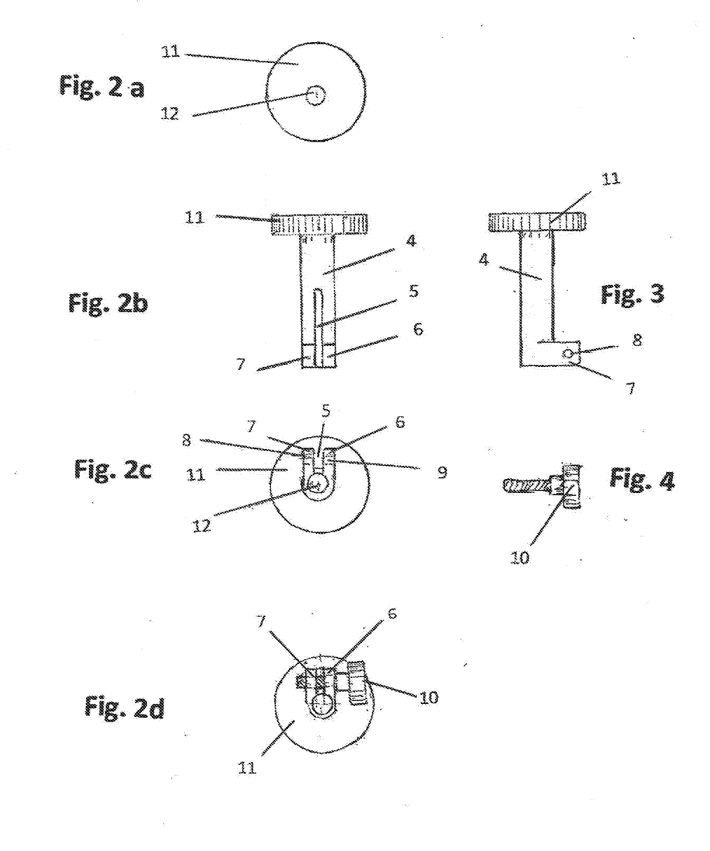

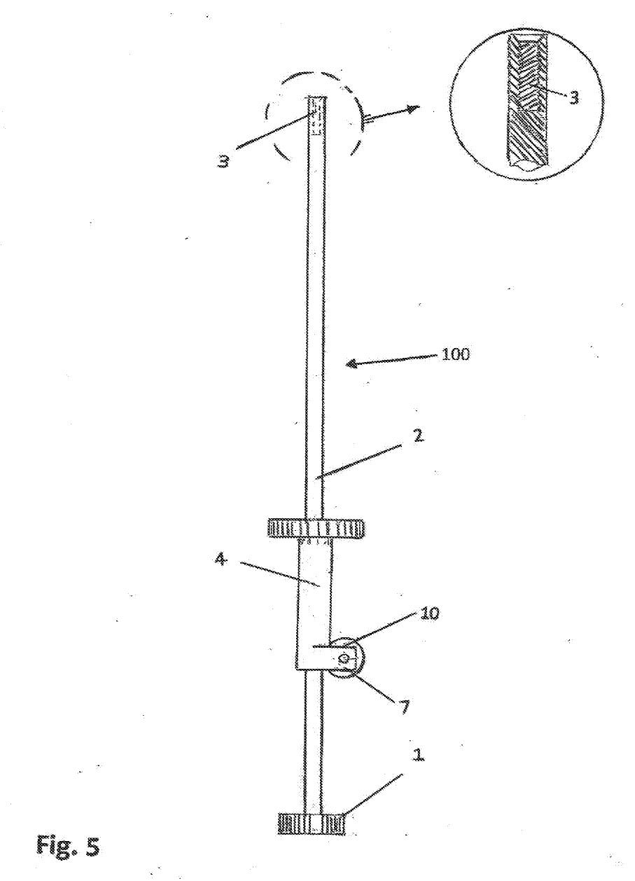

As can be seen by the reference to the drawings, and particularly to FIG. 5, a first embodiment of the fixture installation tool that forms the basis of the present invention is designated generally by the reference number 100. Tool 100 consists of three parts: a guiding rod 2 (FIG. 1), a sliding fixture support 4 (FIGS. 2a, b, c, and d and FIG. 3), and the locking screw 10 (FIG. 4).

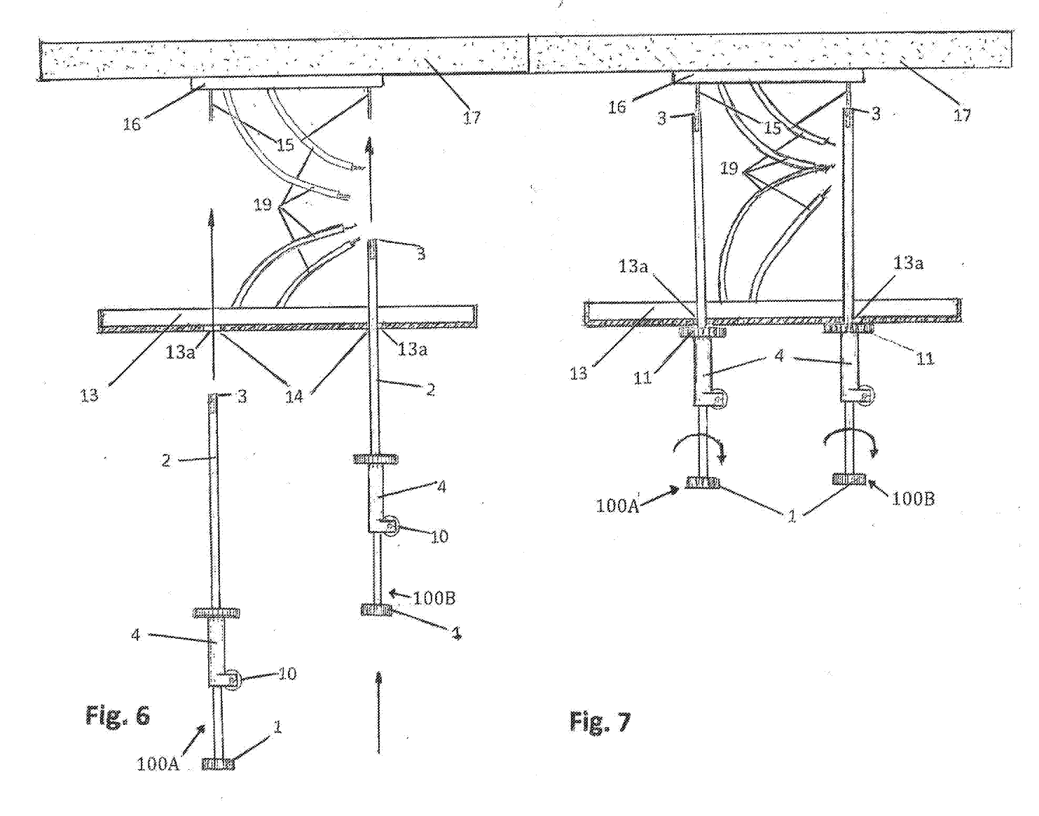

The guiding rod 2 (FIG. 1) has at the distal end 2a a threaded hole 3 with a standard thread which corresponds to the thread of the holding screws 15 (FIG. 6). At the proximal end 2b, the rod has a wheel 1 which facilitates easy rotation of the rod 2 around its axis for attachment to the holding screw 15.

The sliding support 4 (FIG. 2b) has a supporting plate 11. There is a channel 12, through which the guiding rod 2 passes (FIG. 5). At the distal end of the sliding support 4 there is a longitudinal cut in the wall 5 and there are two wings 6 and 7. A hole 8 passes through wing, and a hole 9 passes through wing 6. The hole 9 is not threaded, and the hole 8 (FIG. 2d) is threaded. The locking screw 10 (FIG. 4) is passed through hole 9 and screwed in the threaded hole 8 (FIG. 2d). When the locking screw 10 is turned clockwise it brings the two wings together and locks the sliding support 4 by frictional contact at the desired position on the guiding rod 2. The view from the proximal end of the sliding support 4 is shown in FIG. 2a, and the view from the distal end is shown in FIG. 2c. Another view of the sliding support is shown in FIG. 3. The assembled light fixture tool is shown on FIG. 5.

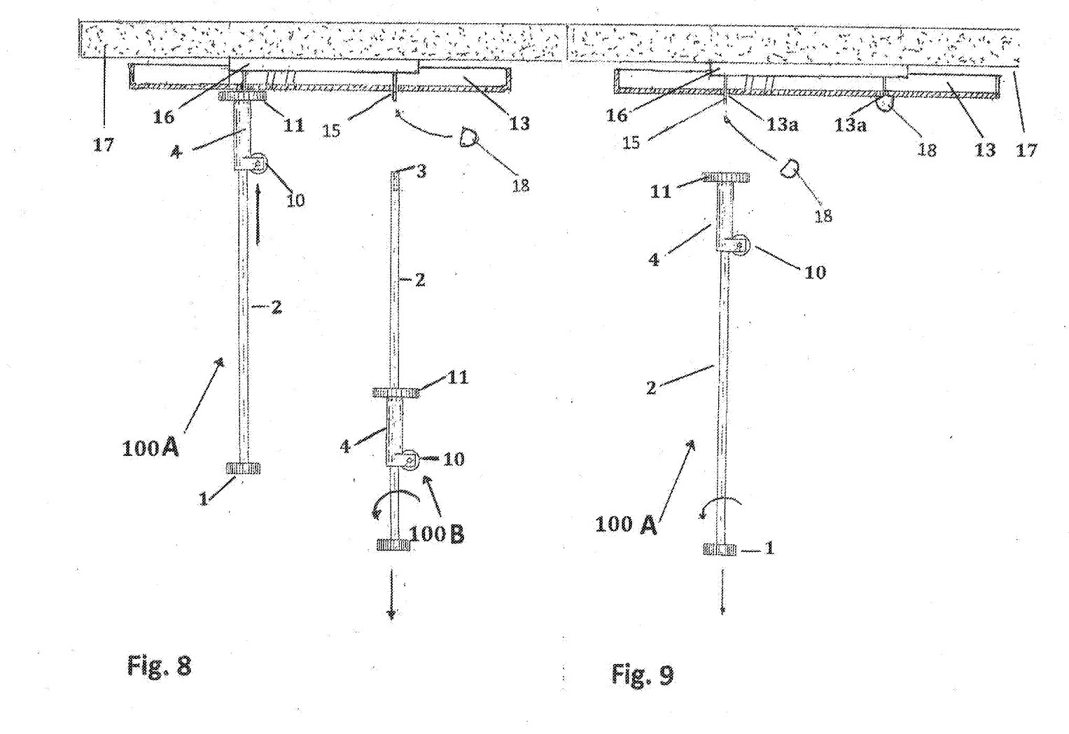

The fixture assembly tool of this first embodiment 100 is used in pairs 100A and 100B (FIGS. 6-8). The installer supports the fixture 13 with one hand and then passes the guiding rod 2 of the fixture tool 100 B (FIG. 6) through one of the mounting holes 13a in the fixture 13. The fixture assembly tool 100 B is moved up and screwed onto one of the holding screws 15 attached to the electric junction box 16, which is attached to the ceiling 17. This is repeated with the fixture tool 100 A as is shown in FIG. 7. The fixture 13 is now will supported by the two supporting plates 11. Now, the installer connects the electric wires 17 (FIG. 7). After that is done the fixture 13 is pushed up with one hand against the ceiling 17, and the sliding support 4 on the fixture assembly tool 100A (FIG. 8) is slid up against the fixture 13, holding it against the ceiling 17 and it is locked in this position by rotation of the locking screw 10. The light fixture 13 is supported by one hand and the light fixture tool 100 B (FIG. 8) is unscrewed and the threaded fixture knob 18 is screwed onto the fixture holding screw 15 which now extends out from the fixture 13. The procedure is then repeated on the other side with light fixture assembly tool A, (FIG. 9)

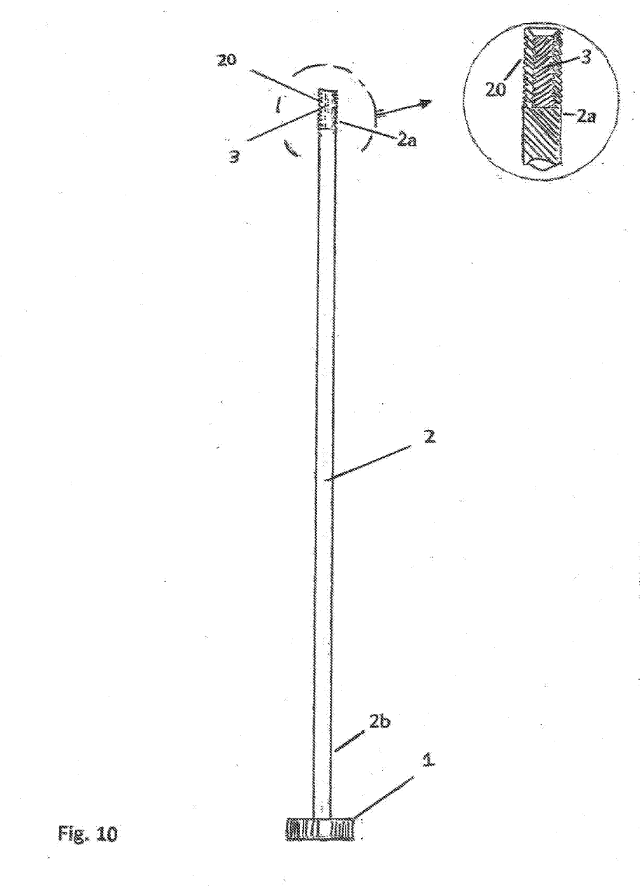

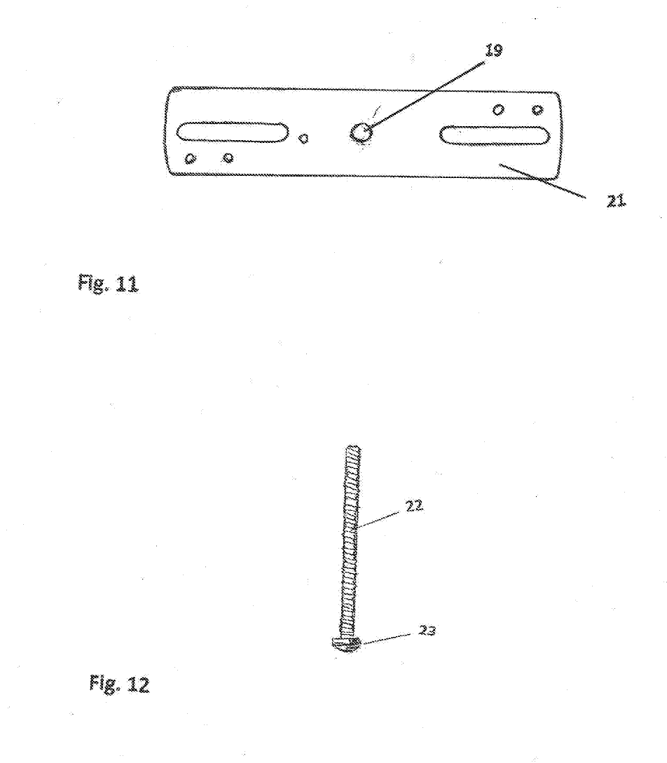

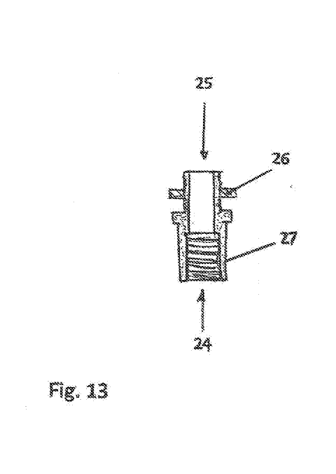

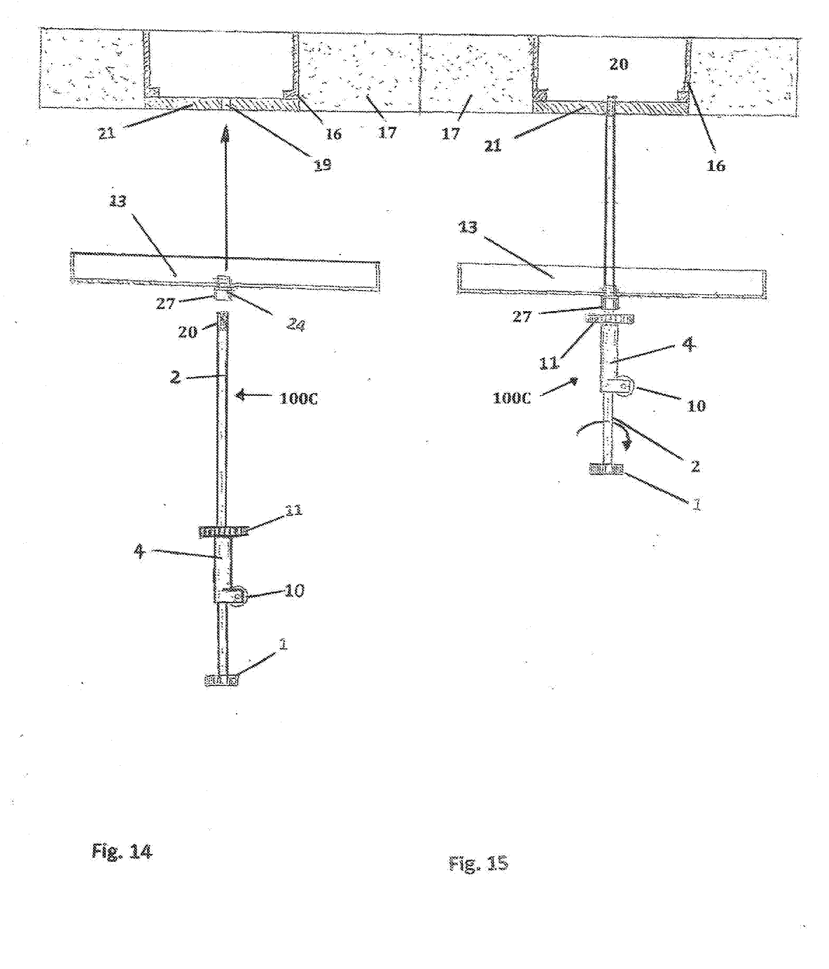

A second embodiment of the light fixture installation tool 100 C is illustrated in FIGS. 10-17. The tool 100C allows attaching a fixture 13 by using only one modified fixture assembly tool 100C (FIGS. 14-16), a custom made crossbar 21 (FIG. 11), a custom made pan head screw 22 (FIG. 12), and a fixture 13 which has a standard fixture nipple holder 27, (FIG. 13).

The first embodiment of the fixture assembly tool 100, has been described in detail above. The modified fixture assembly tool 100C has only one modification. At the distal end 2a of the guiding rod 2 there is a threaded area 20 on the outside surface of the guiding rod 2, which corresponds to the thread and the diameter of the central large hole 19, of the custom made crossbar 21 (FIG. 22).

The custom made crossbar 21 (FIG. 11) is a standard crossbar, only the central large hole 19 is modified, so that its diameter and the thread corresponds to the diameter and the thread of the custom made pan head screw 22 (FIG. 12) and the thread 20 on the distal outside surface of the guiding rod 2 (FIG. 10). This allows both of them to be screwed onto the central large hole 19 of the custom made crossbar 21 (FIG. 11).

The custom made pan head screw 22 (FIG. 12) has a diameter and thread, corresponding to the diameter and the thread of the central large hole 19 of the custom made crossbar 21 (FIG. 11). The head 23 (FIG. 12) of the custom made pan head screw 22 is slightly smaller than the inside diameter of the proximal opening 24 of the fixture nipple holder 27 (FIG. 13). The inside diameter of the distal opening 25 of the fixture nipple holder 27 is smaller than the outside diameter of the head 23. When the custom made screw 22 is inserted through the openings 24 and 25 of the fixture nipple holder 27 and screwed into the central large hole 19 of the custom made crossbar 21, the head 23 can't go through the proximal opening 24, so the light fixture 13 will be attached securely to the custom made crossbar 21. The fixture nipple holder 27 is held in place by a nut 26 (FIG. 13).

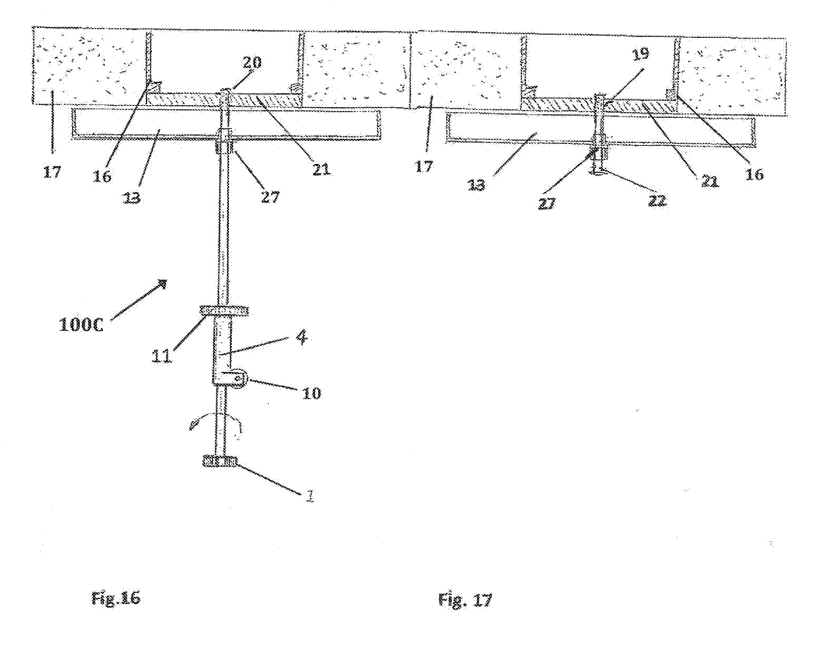

In use, the installer supports the fixture 13 with one hand and passes the distal end 2a of the guiding rod 2 (FIG. 14) through the distal opening 24 of the fixture nipple holder 27 (FIG. 13). The distal end 2a of the rod 2 is moved up and the threaded area 20 is screwed into the central hole 19 of the custom made crossbar 21. Now the fixture 13 is supported by the supporting plate 11 (FIG. 15). The distance between the light fixture 13 and the ceiling 17 can be adjusted by moving the sliding support 4 up or down. The installer connects the electric wires. After that, the light fixture 13 is pushed with one hand up against the ceiling 17 (FIG. 16). The guiding rod 2 is unscrewed from the custom made crossbar 21 by rotating the wheel 1 while holding the light fixture 13 in position with one hand. The custom made screw 22 is inserted through the distal opening 24 of the fixture nipple holder 27 and screwed into the central large hole 19 of the custom made crossbar 21 first by hand, and then with a screwdriver (FIG. 17).

The described second embodiment 100C of the present invention is simple, fast, and secure, and can be used with a fixture 13 which has a fixture nipple holder 27. The described technique of the first embodiment 100A and 100B is complimentary to the second embodiment 100C. Which embodiment is selected, depends upon the fixture design and the preference of the installer.

Also, it is to be understood the tool may be used to install a variety of ceiling mounted electrical fixtures, including light fixtures, ventilation fans, security cameras, speakers, etc.

Although only an exemplary embodiment of the invention has been described in the detail above, those skilled in the art will readily appreciate that many modifications are possible without materially departing from the novel teachings and advantages of this invention. Accordingly, all such modifications are intended to be included within the scope of this invention as defined in the following claims.

1. A tool for installing an electric fixture to a ceiling-mounted electric junction box, the tool comprising:
a guiding rod having a length, a proximal end, and a distal end, the distal end including a threaded portion operably selectively attachable to the junction box;
a fixture support slideably movably attached to the guiding rod, the fixture support being movable between a lowered position and a raised position, and being disposed to engage and support the electric fixture; and
a lock disposed to secure the fixture support at selected positions along the length of the guiding rod.

2. The tool of claim 1, wherein the junction box includes at least one downwardly directed threaded holding screw, and wherein the threaded portion of the distal end of the guiding rod is a female threaded hole sized to be selectively threadably secured to the junction box holding screw.

3. The tool of claim 1, wherein the junction box includes a crossbar having a threaded opening, and wherein the threaded portion of the distal end of the guiding rod is a threaded exterior surface sized to be selectively threadably secured to the threaded opening in the crossbar of the junction box.

4. The tool of claim 2, wherein the junction box includes a pair of spaced downwardly directed holding screws.

5. The tool of claim 1, wherein the proximal end of the guiding rod carries a rotation wheel, whereby selective relation of the guiding rod is facilitated.

6. The tool of claim 1, wherein the fixture support further comprises:
a body member having a longitudinal slot disposed between two movable wing sections; and
a locking screw disposed to selectively engage the wing sections to move them toward and away from each other to adjust the frictional contact between the wing sections and the guiding rod, thereby allowing the movement of the fixture support along the length of the guiding rod between selected locked positions.
